(19) United States
(12) Patent Application Publication
(10) Pub. No.: US 2015/0240995 A1
(43) Pub. Date: Aug. 27, 2015

(54) MODULAR PUMPING APPARATUS

(71) Applicant: Joseph Naumovitz, Lebanon, NJ (US)

(72) Inventor: Joseph Naumovitz, Lebanon, NJ (US)

(21) Appl. No.: 14/708,729

(22) Filed: May 11, 2015

Related U.S. Application Data
(63) Continuation-in-part of application No. 13/753,634, filed on Jan. 30, 2013.
(60) Provisional application No. 61/702,310, filed on Sep. 18, 2012.

(51) Int. Cl. F17C 9/02

(52) U.S. Cl. CPC F17C 9/02

(57) ABSTRACT

A modular pump is in fluid communication with a vaporizer which is in fluid communication with a coolant exchanger. A fluid such as a cryogenic liquid like liquid nitrogen or liquid carbon dioxide is pumped via a high pressure modular pump to the vaporizer where the liquid becomes gas. The higher pressure gas is cooled by a coolant exchanger and can be fed to an onsite unit operation such as an enhanced oil recovery operation. The modular pump is unique to one fluid and may be removed and replaced by a modular pump that is unique to a different fluid. The coolant exchanger is in a thermal exchange relationship with a combustion engine which powers a hydraulic pump which feed hydraulic fluid to drive the high pressure pump.

### CROSS REFERENCE TO RELATED APPLICATIONS

The present application claims priority from U.S. patent application Ser. No. 13/753,634 filed Jan. 30, 2013 and U.S. provisional application Ser. No. 61/702,310 filed Sep. 18, 2012.

### BACKGROUND OF THE INVENTION

The development of enhanced oil recovery projects is complex requiring the methodology to be tailored to each specific oil reservoir. To improve the success of these projects it is often necessary to conduct pilot injection tests to measure well injectivity, areal sweep and conformance, gravity override, viscous fingering, and loss of mobility control. The conditions of the oil reservoir will help to determine whether carbon dioxide or nitrogen is the appropriate fluid for enhanced oil recovery (EOR).

The carbon dioxide or nitrogen that is necessary for EOR must be supplied at higher pressures and requires pumping and vaporization systems. Typically these pumping and vaporization systems are separate systems such that one system provides high pressure carbon dioxide and a second system provides high pressure nitrogen. However, much of the required usage for these gases is for less than one year and each type of system requires significant capital investment.

The present invention is able to overcome this limitation by using an apparatus or a skid that can pump and vaporize either liquid nitrogen, liquid carbon dioxide or a third different fluid such as liquefied natural gas (LNG) to their gaseous state to a location where an operator has need for either of these gases such as for enhanced oil recovery operations,

This is accomplished by using an apparatus that contains a modular pump which can deliver one fluid. When it is desired to deliver a different fluid, the first modular pump can be removed from the apparatus and replaced with a second modular pump for delivering the second, different fluid.

### SUMMARY OF THE INVENTION

The invention provides for an apparatus for providing a gas preferably selected from the group consisting of nitrogen and carbon dioxide for use in operations such as enhanced oil recovery operations comprising a source of the gas and a storage vessel for the gas, utilizing a modular pump, and a single (non-interchangeable) vaporizer system capable providing either gas at a specified delivery pressure and temperature.

The modular pump is defined as a pump which has utility for pumping a single fluid component. The modular pump is constructed such that it will fit into the apparatus for delivering the fluid to the end use such as enhanced oil recovery operation. When the operator determines that a different fluid component should be delivered, then the modular pump can be removed and replaced with another modular pump that is unique to the different fluid and which can be placed into the apparatus with little to no modifications to the connections with the other components of the apparatus. Each modular pump would be unique to a particular fluid so for example, there would be a modular pump for nitrogen, a different modular pump for carbon dioxide and yet another different modular pump for liquefied natural gas, The common denominator is their modularity which allows for one modular pump to literally replace another modular pump so that the same apparatus or skid can be located at an operator's location, such as an enhanced oil recovery operation. The operator then can use a variety of fluids for the enhanced oil recovery operation and utilize the same apparatus or skid by conveniently replacing the modular pump when it is desired to pump a different fluid into the enhanced oil recovery operation.

Preferably the apparatus operates to provide a high pressure gas to an end user for use in enhanced oil recovery operations. The invention preferably starts with liquid carbon dioxide and/or nitrogen, using a modular pump to increase the supply pressure and direct the liquid to an air fan vaporizer. The liquid carbon dioxide or nitrogen or other fluid is typically drawn from a storage tank by the modular pump. The fluid air vaporizer will vaporize the liquid and will provide higher pressure gas to the location where the end user can employ the higher pressure gas in enhanced oil recovery operations. Alternatively the vaporized liquid can simply be fed to a storage unit. The components of the apparatus are fluidly connected by the appropriate piping.

An advantage of the present invention is that the apparatus or skid will contain a vaporizer and coolant exchanger that will operate with a variety of modular pumps. The apparatus can therefore accommodate a variety of fluids and theft vaporized form while only replacing the modular pump when it is desired to use a different fluid. The operator will simply replace one modular pump corresponding to one fluid with another modular pump that corresponds to a different fluid as desired.

For purposes of the invention, the apparatus may be in the form of a skid which contains the elements of the modular pump, the vaporizer and the coolant pump and their respective connections.

The fluid that may be vaporized is typically a liquid cryogen that is selected from the group consisting of nitrogen and carbon dioxide and may also consist of a mixture of nitrogen and carbon dioxide. Other fluids such as liquefied natural gas may also be employed.

The modular pump is typically a high pressure pump that is capable of pressurizing the fluid to a pressure of about 1400 to 5000 psia (pounds per square inch absolute). The modular pump may be assisted by a booster between the source of the fluid and the modular pump.

The fluid is fed to a vaporizer where the fluid becomes a gas.

The vaporizer directs the gas to a coolant exchanger where the high pressure gas is fed to an operation such as enhanced oil recovery operations or to storage for other uses onsite. The coolant exchanger is in a thermal fluid communication with a combustion engine which is powered by a hydrocarbon such as diesel fuel or natural gas. The combustion engine will provide hot engine coolant to the coolant exchanger while the coolant exchanger provides cooled engine coolant to the combustion engine therefore allowing for efficient operation of the combustion engine.

The combustion engine is used to provide power to a hydraulic pump which will draw fluid from a hydraulic fluid reservoir and direct it to hydraulic drivers. The hydraulic drivers convert pressure energy from the hydraulic fluid into mechanical energy. This mechanical energy is transmitted to the booster pump, the modular pump and the vaporizer fan.

It should be noted that the final effluent temperature of the vaporized and heated cryogen is different for each fluid. However, the equipment set functions with the same overall heat transfer characteristics (i.e., overall heat transfer coefficient times effective area is held constant). It should also be noted that the engine's internal cooling system compensates for differences in returning cooled engine coolant temperature.

In a first embodiment of the invention, there is disclosed an apparatus comprising a modular pump, a vaporizer and a coolant exchanger.

The modular pump can receive a fluid and dispense a fluid. The modular pump is in fluid communication with the vaporizer and a source of fluid such as a liquid cryogen like carbon dioxide or nitrogen.

The modular pump is a high pressure pump that can deliver the fluid at pressures of 1400 to 5000 psia.

The coolant exchanger is in fluid communication with the vaporizer. The vaporizer will vaporize one or more fluids without any adjustment to its settings made by the operator.

The vaporized liquid can be fed to an enhanced oil recovery operation or alternatively to storage,

The apparatus further comprises a booster pump in fluid communication with the modular pump. The booster pump will draw in the fluid at about ambient pressure and will dispense the fluid to the modular pump at a pressure of about 100 to 500 psia. The modular pump will then boost the pressure of the fluid to the 1400 to 5000 psia.

### BRIEF DESCRIPTION OF THE DRAWINGS

FIG. 1 is a schematic of the system configured for providing high pressure nitrogen gas per the invention.

FIG. 2 is a schematic of the system configured for providing supercritical carbon dioxide per the invention.

### DETAILED DESCRIPTION OF THE INVENTION

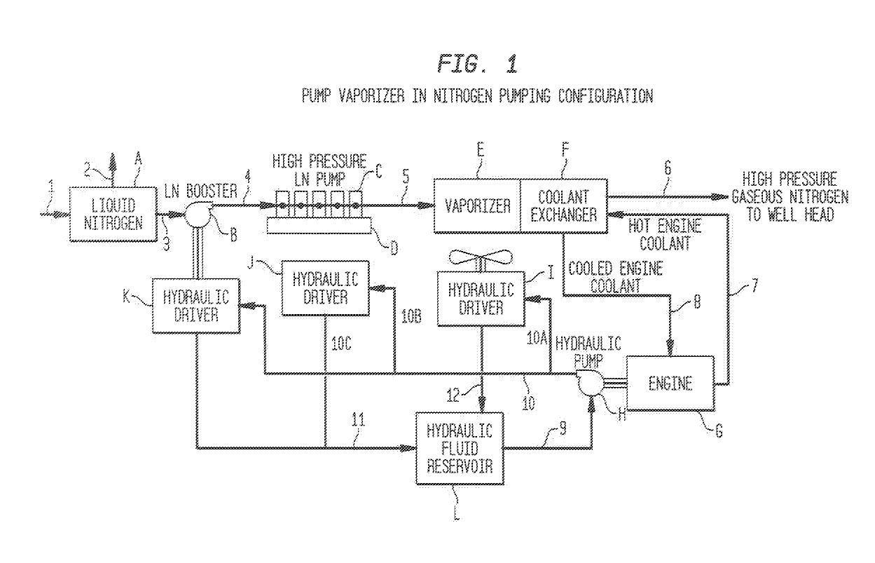

Turning to FIG. 1, a schematic of the invention is shown for pressurizing and vaporizing liquid nitrogen for use in enhanced oil recovery operations. The liquid nitrogen is fed through line 1 to a liquid storage tank A. The storage tank A can be capable of storing either the liquid nitrogen or liquid carbon dioxide which are typically stored at two different temperatures: liquid nitrogen in the range of −320 to −270° F. (−196 to −168° C.) and liquid carbon dioxide in the range of −85 to −45° F. (−65 to −43° C.). Depending on the application, storage tank A consists of a single tank or a series of separate tanks that are manifolded together to form a common liquid nitrogen supply. The storage tank A is able to control pressure in the tank by venting through line 2 any gas present in the storage tank. A pressure building system is included to vaporize a portion of the liquid in order to maintain pressure during operations. The storage tank A can be any storage tank that is used to store liquid cryogenic materials.

A booster pump B will receive a feed of the liquid nitrogen through line from storage tank A. The liquid nitrogen will be fed at a pressure between 100 and 500 psia through line 4 into a high pressure reciprocating pump system C which is the modular pump. This modular pump system is driven by a hydraulic driver D. This driver is common to both nitrogen and carbon dioxide pumping modes. The high pressure liquid nitrogen will be fed through line 5 at a pressure between 1400 and 5000 psia to a nitrogen aft vaporizer E and nitrogen coolant exchanger F. The nitrogen air vaporizer E and coolant exchanger F will vaporize the liquid nitrogen and produce a gas in the pressure range of 1400 to 5000 psia and in the temperature range of 40 to 80° F. (4 to 27° C.). The resulting gaseous nitrogen is fed through line 6 directly to an enhanced oil recovery operation where it can be used in downhole operations. Alternatively, the gaseous nitrogen can be fed to a storage unit (not shown) for later use in the enhanced oil recovery operation.

The pumping and vaporization system is driven by a combustion engine G which can be either diesel or natural gas driven. An engine coolant is used to transfer heat through line 7 to the coolant exchanger F. Engine coolant from the coolant exchanger F is fed to the combustion engine G through line 8.

The pumps and vaporizer fans are driven by means of a hydraulic fluid in the following manner. A hydraulic fluid is fed through line 9 from the hydraulic fluid reservoir L to hydraulic pump H. Line 10 provides pressurized hydraulic fluid to hydraulic driver K and through lines 10A and 10B to hydraulic drivers and J respectively. Low pressure hydraulic fluid is returned to the hydraulic fluid reservoir L through lines 100, 11 and 12.

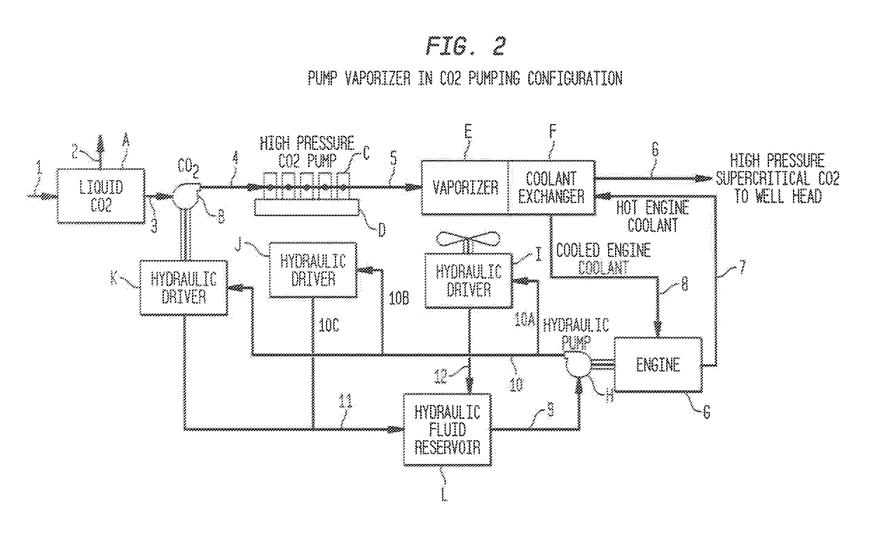

FIG. 2 provides a schematic of the invention is configured for pressurizing and vaporizing liquid carbon dioxide for use in enhanced oil recovery operations. The same number and letter designations are employed in FIG. 2 as are employed in FIG. 1 with the exception that carbon dioxide is being employed in the process of the invention in FIG. 2 while nitrogen is being employed in FIG. 1. Both schematics describe an invention wherein a modular pump can be employed to deliver a fluid.

The following table 1 illustrates operating parameters of this system in two modes of operation. The advantage of this system is that, with identical conditions (flowrate and pressure) entering the vaporizer and engine coolant units, the system produces a pressurized warm fluid stream suitable for use in EOR operations.

TABLE 1

| Fluid | Nitrogen | Carbon dioxide |
|---|---|---|
| Liquid flowrate (gpm) | 45.3 | 45.3 |
| Pump discharge pressure (psig) | 4990 | 4990 |
| Vaporizer Duty (kW) | 484.2 | 259.8 |
| Vaporizer UA (BTU/hr/F) | 16,700 | 16,700 |
| Fluid temp exit vaporizer (F) | 54.7 | 50.0 |
| Engine coolant flow (gpm) | 8.2 | 8.2 |
| Coolant exchanger duty (kW) | 79.2 | 86.9 |
| Coolant exchanger UA (BTU/hr/F) | 8166 | 8166 |
| Fluid temperature exit coolant exchanger (F) | 108.1 | 73.2 |
| Coolant temperature exit coolant exchanger (F) | 80 | 86.9 |

To service carbon dioxide, the booster pump B and the cold end cylinders C of the high pressure pump (modular pump) are replaced with materials compatible for pumping liquid carbon dioxide. The system operates in the same manner as the description for FIG. 1 to produce supercritical carbon dioxide in the pressure range of 1400 to 5000 Asia and in the temperature range of 40 to 80° F. (4 to 27° C.).

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the invention.

Having thus described the invention, what I claim is:

1. An apparatus comprising a modular pump, a vaporizer and a coolant exchanger.

2. The apparatus as claimed in claim 1 wherein the modular pump is in fluid communication with the vaporizer.

3. The apparatus as claimed in claim 1 wherein the coolant exchanger is in fluid communication with the vaporizer.

4. The apparatus as claimed in claim 1 wherein the vaporizer will vaporize one or more fluids without any adjustment to the vaporizer settings.

5. The apparatus as claimed in claim 1 wherein the vaporized fluids are fed to an enhanced oil recovery operation.

6. The apparatus as claimed in claim 1 wherein the fluid is a liquid cryogen.

7. The apparatus as claimed in claim $ the liquid cryogen is selected from the group consisting of carbon dioxide and nitrogen.

8. The apparatus as claimed in claim 1 wherein the modular pump is a high pressure pump.

9. The apparatus as claimed in claim 1 wherein the modular pump is removed from the apparatus.

10. The apparatus as claimed in claim 9 wherein the removed modular pump is replaced by a different modular pump.

11. The apparatus as claimed in claim 1 wherein the modular pump pumps the fluid to a pressure of 1400 to 5000 psia.

12. The apparatus as claimed in claim 1 wherein the vaporizer vaporizes the fluid at a pressure of 1400 to 5000 psia.

13. The apparatus as claimed in claim 1 further comprising a booster in fluid communication with the modular pump.

14. The apparatus as claimed in claim 13 wherein the booster pump draws in the fluid at about ambient pressure and will dispense the fluid to the modular pump at a pressure of about 100 to 500 psia.

15. The apparatus as claimed in claim 1 wherein the coolant exchanger is in thermal fluid communication with an internal combustion engine.

16. The apparatus as claimed in claim 1 wherein the internal combustion engine provides hot engine coolant to the coolant exchanger and the coolant exchanger provides cooled internal combustion engine coolant to the internal combustion engine.

17. The apparatus as claimed in claim 1 wherein the internal combustion engine provides power for a hydraulic pump. cm 18. The apparatus as claimed in claim 1 wherein the hydraulic pump provides hydraulic fluid to a hydraulic driver connected to the hydraulic pump.
